(19) United States
(12) Patent Application Publication
(10) Pub. No.: US 2015/0048528 A1
(43) Pub. Date: Feb. 19, 2015

(54) FILL MATERIAL FOR DIRECT-CONTACT HEAT/MASS EXCHANGERS

(71) Applicant: Sean Anderson Barton, Tallahassee, FL (US)

(72) Inventor: Sean Anderson Barton, Tallahassee, FL (US)

(21) Appl. No.: 14/463,644

(22) Filed: Aug. 19, 2014

Related U.S. Application Data
(60) Provisional application No. 61/867,523, filed on Aug. 19, 2013.
(60) Provisional application No. 61/939,208, filed on Feb. 12, 2014.

(51) Int. Cl. B01J 19/30; F28D 7/16

(52) U.S. Cl. CPC B01J 19/30; F28D 7/16
USPC 261/95

(57) ABSTRACT

Fill material for a direct contact heat exchanger wherein the fill material has flow pathways bounded by an array of linear elements, namely a mesh. The invention intentionally uses surface tension and capillary action to anchor the fluid/fluid interface in a desired location. The heat exchanger is wick or collector in direct contact with the fill material (matrix) to extract fluid without formation of large droplets. The mesh is made from a neutrally wetting material.

This application claims the benefit of U.S. provisional application No. 61/867,523 filed on Aug. 19, 2013 and U.S. provisional application No. 61/939,208 filed on Feb. 12, 2014, each application incorporated herein by reference in its entirety.

### BACKGROUND OF THE INVENTION

1. Field of the Invention

The present invention relates to neutrally-wetting fill material used in direct contact heat/mass exchangers.

2. Background of the Prior Art

A heat/mass exchanger is a device that moves heat and/or a dissolved substance (mass) from one fluid to another fluid. The ideal heat exchanger would move as much heat as is thermodynamically possible, causing the temperatures of the exiting fluids to be the reverse of the temperatures of the entering fluids; thus the exiting heat-sink fluid would be just as hot as the entering heat-source fluid and the exiting heat-source fluid would be just as cold as the entering heat-sink fluid. A practical heat exchanger cannot exchange all of this heat because a small temperature difference must be maintained to drive the heat from the heat source fluid to the heat sink fluid. The ratio of heat exchanged to heat not exchanged in a heat exchanger is called the number of “theoretical plates” or “theoretical stages” by the chemical engineering community. An ideal heat exchanger has a large volume-flow capacity for fluids and a high number of theoretical plates. A mass exchanger is similar in theory to a heat exchanger except that the concept of temperature (which describes the availability of energy) is replaced with the concept of chemical potential (which describes the availability of some dissolved substance). To simplify the discussion from here forward, we will treat only heat exchangers, not mass exchangers. However, it should be realized that there exists a parallel discussion that treats mass exchangers, which replaces heat-related concepts like temperature, thermal conductivity, and heat conduction with mass-related concepts like chemical potential, selective permeability, and diffusion.

Heat exchangers come in two general types, indirect-contact (IDC) heat exchangers and direct-contact (DC) heat exchangers. In the IDC type, the interlaced counter-flowing parallel fluid pathways are separated by barriers or walls of a thermally-conductive fluid-impermeable material (often a metal)(FIG. 13). The heat exchanger can take any of the following forms: plate and frame geometry (common) where the fluid separating barriers are arranged as parallel planes (FIG. 14), tube and shell geometry (common) where the fluid separating barriers are arranged as parallel cylinders (one fluid existing outside the cylinders, the other inside)(FIG. 15), checkerboard geometry (uncommon due to difficulties with fabrication) where a cross-section perpendicular to the fluid pathways shows the two fluids present in alternating squares, isometric geometry (also uncommon due to difficulties with fabrication) where a cross-section perpendicular to the fluid pathways shows the two fluids present in alternating equilateral triangles, and hexagon-triangle geometry (also uncommon due to difficulties with fabrication) where a cross-section perpendicular to the fluid pathways shows a tessellation of alternating equilateral triangles and regular hexagons where one fluid exists in the hexagons and the other in the triangles. The various designs have different conveniences related to maintenance, cleaning, and modularity but are functionally more or less equivalent.

In a DC type heat exchanger, a wall or matrix is provided for one fluid to run over while the other fluid moves through the open spaces (FIG. 16). Thus the heat exchanger is still composed of interlaced counter-flowing parallel fluid pathways, but these pathways are no longer separated by barriers or walls. The fluids are instead caused to stay in their designated spaces by allowing one of the two fluids to adhere to a wall or matrix. The wall or matrix need not be thermally-conductive or fluid-impermeable as it does not serve to keep the fluids separate or transmit heat from one fluid to the other and is located in the middle of one of the fluid pathways. In this way the fluids touch each other directly and exchange heat through this contact. In such arrangements, it is found to be advantageous that the fluid running over the wall or matrix adheres more strongly to the wall or matrix than the other fluid does. The walls or matrixes can be arranged as parallel planes (similar to the plate-and-frame type geometry of IDC heat exchangers)(FIG. 17) or in other geometries. For example, because there is no desire to keep the fluids separate in a DC heat exchanger, the heat exchange volume can even be filled with “aggregate” material as opposed to the organized “structured” materials. One example of such aggregate fill material is Raschig Rings (FIG. 18). They are hollow cylinders with open ends having a length approximately equal to their diameter. They are placed into the heat exchange volume in aggregate, taking random orientations. In operation, one of the two fluids forms a film over the inside and outside surface of the cylinder while the other fluid moves around the outside of the cylinder and through the central space of the cylinder. A nearly endless variety of structured and aggregate fill materials are possible for DC heat exchangers.

IDC heat exchangers have some advantages over DC heat exchangers. IDC heat exchangers prevent mass exchange when it is not desired. For example, if one wishes to move heat from freshwater into saltwater, the exchange of salt between the two waters may not be desired. IDC heat exchangers also allow for the two fluids to be at different pressures and thus the speed of each fluid can be changed independently by changing the gradient of these pressures. The pressure gradients can also overcome the weight of the fluids allowing the heat exchangers to be oriented in any way desired, including having the more dense fluid flowing downward and the less dense fluid flowing upward as is required in DC heat exchangers.

In turn, DC heat exchangers also have some advantages over IDC heat exchangers. Because heat exchange does not occur through a solid material, mineral scale cannot grow on the heat exchange surface and hinder the heat exchange. DC heat exchangers also allow mass exchange when it is desired. For example, when one attempts to humidify a stream of air with hot water, mass must be permitted to move from the water into the air. Because DC heat exchangers do not require solid walls or barriers to keep the fluids separate, less material can be used. Even non-solid materials like meshes can be used. Additionally, because this material does not need to transmit heat, good thermal conductivity is not required. Expensive metals can thus be replaced with lower-cost plastics, glasses, or ceramics. Finally, since there is no attempt to keep the fluids separate, there is no concept of an internal plumbing leak. The large number of gaskets and seals and welded joints required to leak-tight a IDC heat exchanger are not needed. Only the outer volume of the heat exchanger needs to be sealed.

Though DC heat exchangers must be operated with fluids that are immiscible (to prevent mixing into one fluid), of different densities (to drive fluid movement), and of the same pressures (to prevent crossover), any desired heat exchange process can still be accomplished with DC Heat exchangers by placing two DC heat exchangers in series so that the two fluids do not exchange heat/mass directly, but instead exchange the heat/mass with an intermediate fluid. Because DC heat exchangers are of much lower cost relative to IDC heat exchangers, this approach can be economically viable. The intermediate fluid is chosen so that it is immiscible with and of a different density than both of the primary fluids. Either primary fluid or the intermediate fluid can be pumped and throttled with a regenerative pump to accommodate any differences in pressure. A height difference may also accommodate differences in pressure.

DC heat exchangers also have a number of existing problems. Fluid films moving over solids (under the influence of gravity) tend to be of non-uniform thickness because of the tendency of thicker films to move with greater speed. Thus, the distance of the fluid/fluid interface from the solid surface in not stable or uniform. The non-uniformity leads to non-uniform heat exchange as the thicker films require more time for heat exchange to occur but also spend less time in the heat exchange environment due to their higher speed. Further, for high heat-exchange densities, small fluid pathways are needed to provide large amounts of surface area for heat exchange in a given volume. In a DC heat exchanger, when fluid pathways are too small, surface tension and capillary action can act to flood the fluid pathway with one fluid, completely excluding the other fluid, and thus preventing heat exchange. These effects are more pronounced when fluid pathways are small, as capillary pressure is inversely proportional to the diameter of the fluid pathway (FIG. 19). It is for this reason that Raschig Rings are less common in sizes below about 3 mm for smaller sizes are prone to flooding. This can be somewhat addressed by using larger Raschig Rings only in the discharge area. Finally, while the solid material serves to guide the fluid along its path, it also slows the fluid down. A reduction in fluid velocity corresponds to a reduction in volume-flow capacity for the entire heat exchanger. While a reduction in fluid pathway size increases total contact area per volume and thus increases heat exchange density, it also reduces fluid velocity. Thus, reducing friction allows for either a higher volume-flow capacity or (when it is coupled with a reduction in fluid pathway size) an increase in heat exchange density without a loss of volume-flow capacity. The problem of inadequate velocity is often not encountered in DC heat exchangers because the flooding effects prevent reductions in fluid path size that would expose the problem. In light of these problems, it is naively desired to have the fluid arrangement found in an IDC heat exchanger where solid materials do not exist in the middle of a fluid pathway causing large amounts of friction, but also without the reduction of heat/mass transfer and increased expense created by its fluid-impermeable, thermally-conductive walls. One may initially simply remove the walls and allow the fluids to remain in the same fluid pathways while touching each other directly (FIG. 20). However, this arrangement is not stable because the Plateau-Rayleigh instability (FIG. 21) causes the sheets of fluid to form into droplets and clumps that reduce total contact area and heat exchange density (FIG. 22). These droplets (through fluid-dynamic and surface-tension effects) continue to combine into larger and large droplets thus reducing heat exchange. Keeping the droplets finely subdivided in these situations proves to be very difficult or nearly impossible. Thus, it is desired to anchor the fluid/fluid interfaces into the chosen geometry and to hold them in these locations to allow for more consistent film thicknesses and smaller non-flooding fluid pathways and the resulting more consistent and higher density exchange of heat. It is desired to accomplish this with a minimum of solid material producing a minimum of resistance to fluid flow and heat/mass exchange and having a minimum of material cost.

In understanding the present invention, a discussion of the interaction of fluids with solids at small length scales is desired. Because pressures generated by capillary action and surface tension are inversely proportional to the characteristic linear dimension of the system considered, we find that these forces are very strong compared to gravity when small length scales are considered. Take a drop of water sitting on a table, for example. If the drop is very small (perhaps less than 1 mm), it will take a shape that is almost perfectly round though not an entire sphere. Depending on what the table surface is made of, this may be more or less than a hemisphere, but the surface of the drop will follow almost exactly the curvature of a sphere. This shape is governed almost entirely by surface tension which acts to minimize the surface area for the volume contained. If the drop is larger however (say 10 mm), it will be seen that the drop's surface follows the curve of a flattened sphere (an ellipsoid). This departure from the spherical shape is caused by the self-weight of the water; gravity flattens the drop. In the absence of gravity, this drop too would follow the curvature of a sphere. Now considering only the small drops (which are most relevant to the small fluid pathways envisioned in the heat exchanger of the current invention), we desire an exploration of what effect the choice of table surface material will have on the shape of the drop. If the table surface is made of glass, the drop will tend to spread out assuming a shape that is less than a hemisphere (FIG. 23). If the table surface is made of some common plastics, the drop will assume a shape that is almost exactly a hemisphere (FIG. 24). If the table surface is made of polytetrafluoroethylene (PTFE, e.g., DuPont Teflon), the drop will pull together and assume a shape that is more than a hemisphere, approaching the shape of a complete sphere (FIG. 25). The water is often said to “bead up” in these cases. In the neutral case (FIG. 24) the edge of the droplet meets the solid surface at an exact perpendicular. This is called (by definition) a neutral wetting condition. In the first example (FIG. 23), it is said that water “wets” a glass surface in air because the angle of the water at the glass surface is acute. In the last example (FIG. 25), it is said that water “does not wet” a PTFE surface in air because the angle of the water at the PTFE surface is obtuse. Which of these three behaviors occurs when a fluid is placed in contact with a solid surface in the presence of another fluid is determined by which of the two fluids adheres to the solid surface more strongly. In the case of glass, water adheres more strongly than air. In the case of PTFE, air adheres more strongly than water. (This language is somewhat approximate. For more scientific accuracy we should replace “adheres more strongly” with “has the lower surface energy density” where surface energy includes all forms of potential energy that are proportional to the area of the interface surface). Considering situations in which the roles of the fluids are reversed, for example, a bubble of air in an environment of water stuck to a PTFE surface will look much the same as any other droplet in a wetting condition (occupying a volume less than a hemisphere) (FIG. 23). The same bubble stuck to a glass surface will illustrate the non-wetting condition (occupying a volume that is greater than a hemisphere) (FIG. 25). The bubble will not detach from the surface unless it is large enough to have sufficient buoyancy to detach, just as a drop of water will not fall from a solid in air until it has sufficient weight to do so. Furthering considering other fluid pairs, for example, water and some common oil, it is found that a drop of water does not wet a plastic surface in an oil environment. This is because the oil adheres to the plastic more strongly than the water does. In all of these examples where the two fluids meet with the solid, the fluid having the greater adhesion will occupy the acute angle and the fluid having the lesser adhesion will occupy the obtuse angle. If the fluids have exactly equal adhesions, they will both occupy right angles.

Now let's consider how these adhesion forces affect solid particles that intersect with a fluid/fluid interface. If a small particle or rod (having negligible weight) of some neutrally-wetting plastic is placed on the surface of an air/water interface, that particle will be held at that interface so that the 90 degree contact angles characteristic of neutral wetting (although angles between about 60 to about 120 degrees are consistent with neutral wettin) are achieved (FIG. 26). This places the plastic particle or rod halfway between the fluids. If the particle or rod is made of some water-wetting material (like glass) the rod will rest closer to the water so that the correct contact angle is achieved (FIG. 27). Likewise, if the particle or rod is made of some air-wetting material (like PTFE) the rod will rest closer to the air so that the correct contact angle is achieved (FIG. 28). The rod is held in the location with some force. For example, if an attempt is made to push the neutrally-wetting rod into the water, the water/air interface will deflect so that the surface tension can counteract the applied force (FIG. 29). As long as the lines of fluid/fluid/solid intersection do not fully meet or converge to a point, the surface tension will continue to apply force to the rod. Once the lines have converged and the rod is fully submerged in the water, surface tension will no longer apply forces to it. By simple geometrical consideration, one can see that for a water wetting material, there is less resistance available to prevent the rod from being forced into the water (FIGS. 30 and 31), though attempts to push the rod into the non-wetting fluid are resisted equally well (FIG. 32). These observations inspire us to envision an array of linear elements arranged to form a mesh-like boundary. Thus, we find that an array of linear elements (or mesh) is able to keep two fluids separate by virtue of the fluid/fluid interface being attached to the solid elements and having surface tension (FIG. 33). We find that even when pressure is applied to one fluid in an attempt to force the fluid into the other volume, the mesh is able to respond with some resistive force (FIG. 34). It can be shown (in two dimensions) that the radius of curvature of the menisci is equal to the surface tension of the fluid/fluid interface divided by the pressure difference between the two fluids. Thus, the maximum pressure difference that can be withstood by the menisci corresponds to the minimum radius of curvature of the menisci. This minimum radius of curvature is achieved when the bulging meniscus assumes approximately the shape of a semi-circle (in two dimensions) or a hemisphere (in three dimensions). This minimum radius can be further reduced by providing a mesh with smaller openings. Once the bulging meniscus bulges beyond this semi-circular or hemispherical geometry, it will then continue to expand, providing less and less resistance to the pressure. This is similar to inflating a round balloon. One finds that if the balloon can be inflated beyond a certain size, that the back pressure (resistance to further inflation) begins to reduce. Thus, the fluid has now breached the mesh and has moved into the lower pressure volume. It can be seen in two dimensions by simple geometrical arguments, that when the diameter of the linear elements is less than the spacing of the linear elements, the greatest range of resistible pressures is achieved when the mesh is formed of a neutrally-wetting material. In the presence of these neutrally-wetting linear elements, the fluids (if supplied in volume) will continue to advance through the matrix of linear elements moving through the largest available apertures (where the semi-circular or hemispherical condition is achieved at lower pressure). One could thus form a mesh tube that can contain a fluid (FIG. 35). The mesh tube would be like a conventional hollow tube except that the solid walls of the tube would be replaced with perforated walls having apertures as large as possible only leaving behind thin skeletal linear elements which define the surface of the tube. However, if the walls of the mesh tube are too close to each other or the mesh openings are too large, the fluid will elect to leave the mesh tube instead of remain inside (FIG. 36). In some geometries of the linear elements, where it is desired to place two fluids in contact for heat exchange, the fluid arrangement can be achieved only by introducing the fluids in a particular order. For example, consider an arrangement where Fluid A and Fluid B are separated by parallel planar mesh elements (FIG. 37). If the inter-mesh spacing for fluid B is smaller than the mesh aperture, starting with fluid B in place and then introducing fluid A works fine (FIG. 38). However, if fluid A is in place first and fluid B is introduced second, its desire to move through the largest openings thwarts the desired arrangement of the fluids for heat exchange (FIG. 39). As we originally desired, the forces which keep the fluids in the proper locations become stronger as we reduce the characteristic length scale (size) of the system further. Thus we have created a type of DC heat exchanger that has greater fluid stability at smaller size (not at larger size as is common in current DC heat exchangers). Capillary action and surface tension (which act to disrupt the function of conventional DC heat exchangers as fluid pathway size is reduced) act to enhance the function of the DC heat exchanger of the current invention.

However, some problems still remain. As size is reduced yet further, one will eventually find that gravity and the density difference of the fluids provide for inadequate fluid velocity to permit a heat exchanger of sufficient fluid volume-flow capacity. At extremely small heights, undesired direct heat conduction from the hot end of the heat exchanger to the cold end of the heat exchanger will begin to compete with the desired heat conduction from the heat source fluid to the heat sink fluid. Thus, the smallness of the fluid pathways are still limited, but no longer by surface tension and capillary action.

For the above structure to act as a practical heat exchanger in three dimensions, it must be given mechanical stability by self-connecting the linear elements with additional linear elements that are for mechanical structure only. Fluid/solid interactions in three dimensions are analogous to the two-dimensional examples that we have presented. The concept of contact angles remains the same. Pressure difference across a curved surface-tensioned fluid/fluid interface is calculated differently in three dimensions depending on what type of curve the meniscus follows.

For cylindrical curves:

ΔP=Υ/R

for spherical curves:

ΔP=2Υ/R

for ellipsoidal curves:

ΔP=Υ(1/R₁+1/R₂)

for saddle-like curves:

ΔP=Υ(1/R₁−1/R₂)

where P is the pressure on the concave side of the meniscus minus the pressure on the convex side of the meniscus, where Υ is the surface tension, where R is the radius of the curvature of the meniscus, where the subscripts 1 and 2 represent the smaller and the larger respectively of the radii of principle curvature. In the case of saddle-like curvature where both sides of the meniscus are concave/convex, the side with the smaller radius of concave curvature is considerws to be the concave side of the meniscus.

### SUMMARY OF THE INVENTION

The purpose of the fill material for direct contact heat/mass exchangers of the present invention is to alleviate the dysfunctions of current DC heat exchangers, to allow for DC heat exchangers with small fluid pathways that do not flood, where the fluid/fluid interface is stably anchored in the desired location, and where the frictions on the movements of the fluids are not unnecessarily high, thus allowing for yet greater reductions in fluid path size leading to even higher densities of heat exchange.

The preferred embodiment for contoured heat/mass exchange of air and water in an evaporator or condenser is shown in the FIGS. 11 and 12. The larger volume is devoted to the air because of its lower heat capacity and related larger volume flow requirements. This preferred embodiment has the following advantages. It can be produced with an additive manufacturing process that deposits linear elements of material through an extrusion nozzle (like 3D printing). The indicated angle is kept at less than 60 degrees to eliminate the need to introduce the fluids in a particular order. By arranging the fluids into volumes separated by parallel planes (similar to a plate and frame heat exchanger, not a tube and shell heat exchanger) both fluids are allowed to flow not just in one direction but in two perpendicular directions. It may be found that one of the directions provides less resistance to fluid flow. Both dimensions of flow may be used simultaneously as oblique flow is required in contoured heat exchangers. Because the fluid/fluid interface anchoring elements are staggered, they provide less resistance to and congestion of the fluid flow and allow for a greater area fraction of open aperture between the fluids (providing more heat/mass exchange, less friction, and less material cost) while still providing mechanical structure.

The preferred embodiment for non-countered DC heat exchange of water and some common oil is likely similar to the hexagon-triangle geometry shown in FIGS. 5 and 6. While this geometry does not allow for contoured heat exchange because the fluid pathways are in a closed-cell arrangement, contours are not needed for oil/water because the heat capacity of the oil and water are both sufficiently independent of temperature. The hexagon-triangle geometry allows for one of the two fluids (fluid A in FIGS. 5 and 6) to have larger fluid pathways to better accommodate the low heat capacity and high viscosity of one of the fluids, in this case the oil. Additionally, the hexagon-triangle geometry does not need any structural elements that do not also serve to anchor the fluid/fluid interfaces. Thus, it may have less friction for the same heat exchange compared to the preferred embodiment for air/water.

While it is desired to provide manifolds for the distribution and recollection of the fluids, such manifolds are not required. Distribution can often be accomplished with a spray of the fluid which occupies the minority of the volume. If the heat exchanger of the current invention begins in an atmosphere of fluid A and fluid B (the minority volume fluid) is sprayed upon it, droplets of fluid B will adhere to the linear elements and grow as they collect more droplets from the spray. When the droplets have grown large enough to touch neighboring droplets, they will spontaneously combine and with their increased weight begin to move downward through the matrix of linear elements filling the channels of smaller size. In cases where volume is divided roughly equally between the two fluids and neither fluid occupies a minority volume (as in the embodiments of FIGS. 3, 7, 8, 9, and 10, spray accumulation will fill the compartments indiscriminately and is thus inadequate. In these cases manifolds are required. When the fluid A reaches the bottom of the heat exchanger it can be discharged from the heat exchanger by wicks of a wetting material of sufficient length. To reduce the amount of space needed and eliminate the need for the wicks and the maintenance, energy consumption, misting, and fluid crossover issues associated with operating sprayers, it is desired to provide manifolds that inject and extract the fluids into and out of their respective spaces in the matrix of linear elements. Such manifolds do not have to be sealed to the heat exchanger (matrix or fill material) as they must be in an IDC heat exchanger, but simply need to be in close proximity to it (almost touching or touching such that any gaps are smaller than the mesh aperture). To minimize back pressure in these distributing and collecting manifolds, especially for any fluid which requires high pumping energy, branching fluid pathways (similar to the arteries and veins in the human body) should be used. For a fluid requiring lower pumping energy, the remaining space within the manifold (the space not occupied by the high-pumping-energy fluid) is often fully adequate to facilitate the distribution and recollection of the low-pumping-energy fluid. When both fluids require high pumping energy, distributor/collectors must be of larger size to accommodate the required cross-sectional area for flow of both fluids.

Thus, the fill material for direct contact heat/mass exchangers of the present invention has many critical advances in the art. Specifically, the fill material for direct contact heat/mass exchangers is a direct contact heat exchanger fill material that has flow pathways bounded by an array of linear elements or mesh. Preexisting DC heat exchangers allow one of the two fluids to coat the mesh. Stated differently, the mesh is inside one of the fluids and does not touch the other fluid. In the fill material for direct contact heat/mass exchangers, the mesh is placed between the two fluids, so that the mesh is touching both fluids, much like the thermally-conductive fluid-impermeable barriers are placed in an IDC heat exchanger. In a conventional type DC heat exchanger, wetting surfaces are advantageous. In the fill material for direct contact heat/mass exchangers, neutrally wetting surfaces are advantageous allowing for a much greater variety of materials. The fill material for direct contact heat/mass exchangers intentionally uses surface tension and capillary action to anchor the fluid/fluid interface in a desired location. The fill material for direct contact heat/mass exchangers uses a wick or collector in direct contact with the fill material (matrix) to extract fluid without formation of large droplets. When fluid pathways become very small, even a single drop of liquid can be large enough to block a neighboring pathway for intake of the other fluid. Stated differently, when fluid pathways are very small, discharging drops of fluid inflate to inconveniently large size before becoming heavy enough to detach (forming a single drop). These drops can be large enough to block neighboring fluid intake channels. The fill material for direct contact heat/mass exchangers -uses a distributor in direct contact with the fill material (matrix) or a sprayer to place the fluids in the appropriate fluid pathways. The fill material for direct contact heat/mass exchangers uses fluid/fluid interface anchoring with a discharge system in direct contact. The interface anchoring prevents flooding and allows reduction in fluid pathway size. At smaller fluid pathway sizes the problems with discharge become more obvious. The fill material for direct contact heat/mass exchangers can direct the fluid into spaces arranged as parallel planes to permit oblique flow of the fluids.

This geometry is especially valuable in that it can be used with the contoured heat exchangers. So instead of mesh tubes (similar to a tube and shell geometry), mesh walls (similar to a plate and frame geometry) can be used when considering contoured heat exchange. The mesh boundaries can consist of linear elements that run vertically, that run horizontally, or that run both vertically and horizontally.

### BRIEF DESCRIPTION OF THE DRAWINGS

FIG. 1 is a schematic view of a typical direct contact heat exchanger wherein fluid A is a low-density high-pumping-energy fluid and fluid B is a high-density low-pumping-energy fluid.

FIG. 2 is a schematic view of a typical direct contact heat exchanger wherein fluid A is a high-density high-pumping-energy fluid and fluid B is a low-density low-pumping-energy fluid.

FIG. 3 is a plan view of a zig-zag folded mesh fill material embodiment of the fill material for direct contact heat/mass exchangers of the present invention.

FIG. 4 is a perspective view of a simple procedure used to produce the zig-zag folded mesh fill material of FIG. 3.

FIG. 5 is a plan view of a hexagon-triangle configuration mesh fill material of the fill material for direct contact heat/mass exchangers.

FIG. 6 is a perspective view of the hexagon-triangle configuration mesh fill material of FIG. 5.

FIG. 7 is a plan view of a square configuration mesh fill material of fill material for direct contact heat/mass exchangers.

FIG. 8 is a perspective view of the square configuration mesh fill material of FIG. 7.

FIG. 9 is a plan view of a triangle configuration mesh fill material of the fill material for direct contact heat/mass exchangers.

FIG. 10 is a perspective view of the triangle configuration mesh fill material of FIG. 9.

FIG. 11 is a schematic view of a mesh fill material of the fill material for direct contact heat/mass exchangers for a contoured heat exchanger.

FIG. 12 is a perspective view of a mesh fill material of FIG. 11.

FIG. 13 is a sectioned view of a typical indirect contact heat exchanger.

FIG. 14 is a sectioned view of a plate and frame indirect contact heat exchanger.

FIG. 15 is a sectioned view of a tube and shell indirect contact heat exchanger.

FIG. 16 is a sectioned side view of a typical direct contact heat exchanger.

FIG. 17 is a sectioned top view of a parallel plane geometry direct contact heat exchanger.

FIG. 18 is a sectioned view of a Raschig Ring.

FIG. 19 illustrated fluid pathway flooding due to surface tension and capillary action.

FIG. 20 illustrates basic fluid pathways in a direct contact heat exchanger.

FIG. 21 illustrates initial Plateau-Rayleigh instability of the basic fluid pathways of FIG. 20.

FIG. 22 illustrates the further progression of the Plateau-Rayleigh instability of the basic fluid pathways of FIG. 20.

FIG. 23 illustrates a drop of water on a glass surface assuming a less than hemispheric shape.

FIG. 24 illustrates a drop of water on a plastic surface assuming a hemispheric shape.

FIG. 25 illustrates a drop of water on a PTFE surface assuming a more than hemispheric shape approaching a complete sphere.

FIG. 26 illustrates a small particle or rod a neutrally-wetting plastic placed on the surface of an air/water interface with the particle held at that interface so that the contact angles are 90 degrees.

FIG. 27 illustrates the particle made of a water wetting material, such as glass, resting closer to the water.

FIG. 28 illustrates the particle made of an air wetting material, such as PTFE, resting closer to the air.

FIG. 29 illustrates pushing of the neutrally-wetting particle rod into the water so that the water/air interface deflects so that the surface tension can counteract the applied force.

FIG. 30 illustrates a water wetting particle being forced into the water just before detachment.

FIG. 31 illustrates the water wetting particle being forced into the water just after detachment.

FIG. 32 illustrates the water wetting particle being forced into the non-wetting fluid (air).

FIG. 33 illustrates the concept of having linear elements formed into a mesh like boundary separating two fluids.

FIG. 34 illustrates the application of force onto one of the fluids of FIG. 33, in order to try to force the fluid into the other fluid.

FIG. 35 illustrates a cross-section of a neutrally-wetting mesh tube being filled with a fluid.

FIG. 36 illustrates the effects of the mesh tube of FIG. 35 with the walls too close or the openings too large.

FIG. 37 illustrates a heat exchanger with linear element geometry. FIG. 38 illustrates the heat exchanger of FIG. 37 wherein fluid B is in place and fluid A is introduced.

FIG. 39 illustrates the heat exchanger of FIG. 37 with fluid A in place and fluid B introduced.

Similar reference numerals refer to similar parts throughout the several views of the drawings.

### DESCRIPTION OF THE PREFERRED EMBODIMENT

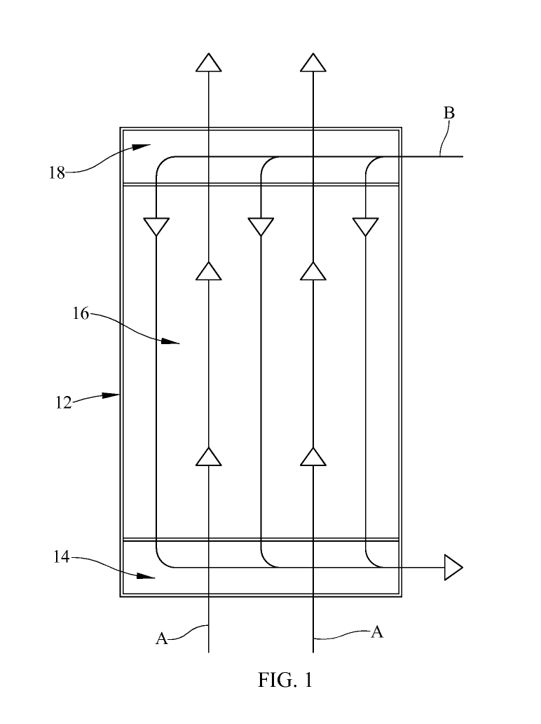

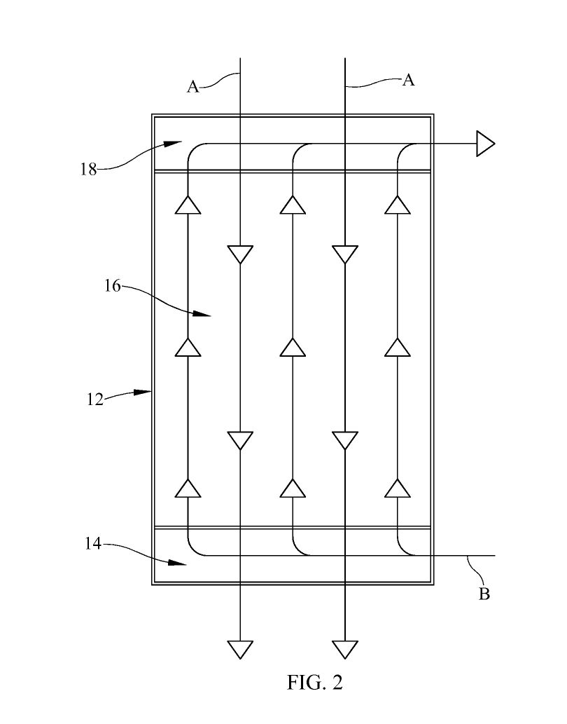

Referring now to the drawings, and specifically to FIGS. 1 and 2, it is seen that the fill material for direct contact heat/mass exchangers of the present invention, is used in a typical direct contact heat exchanger, which may or not be contoured—contoured heat exchangers are disclosed in patent application Ser. No. 14/242,635 filed on Apr. 1, 2014, and incorporated herein by reference in its entirety. Such direct contact heat exchangers may have fluid distributors/collectors of various forms depending on how much energy is required to move the fluids and the amount of energy available to perform the task. In a first possibility illustrated in FIG. 1, the heat exchanger 12 has a first fluid A that is a low-density, high-pumping-energy fluid and a second fluid B, which is a high-density low-pumping-energy fluid, with the first fluid

A entering the heat exchanger 12 at its bottom and flowing upwardly through a lower fluid distributor and collector 14, through the fill material 16 of the present invention, through an upper fluid distributor and collector 18 and out through the top of the heat exchanger 12, while the second fluid B enters the heat exchanger 12 from the side of the upper fluid distributor and collector 18, flows through the fill material 16, flows through the lower fluid distributor and collector 14, and exits the heat exchanger 12 through the side of the lower fluid distributor and collector 14.

Alternately, as seen in FIG. 2, the first fluid A is a high-density high-pumping-energy fluid and the second fluid B is a low-density low-pumping-energy fluid. The first fluid A enters the heat exchanger 12 at its top, flowing downwardly through the upper fluid distributor and collector 18, through the fill material 16 of the present invention, through the lower fluid distributor and collector 14 and out through the bottom of the heat exchanger 12, while the second fluid B enters the heat exchanger 12 from the side of the lower fluid distributor and collector 14, flows through the fill material 16, flows through the upper fluid distributor and collector 18, and exits the heat exchanger 12 through the side of the upper fluid distributor and collector 18.

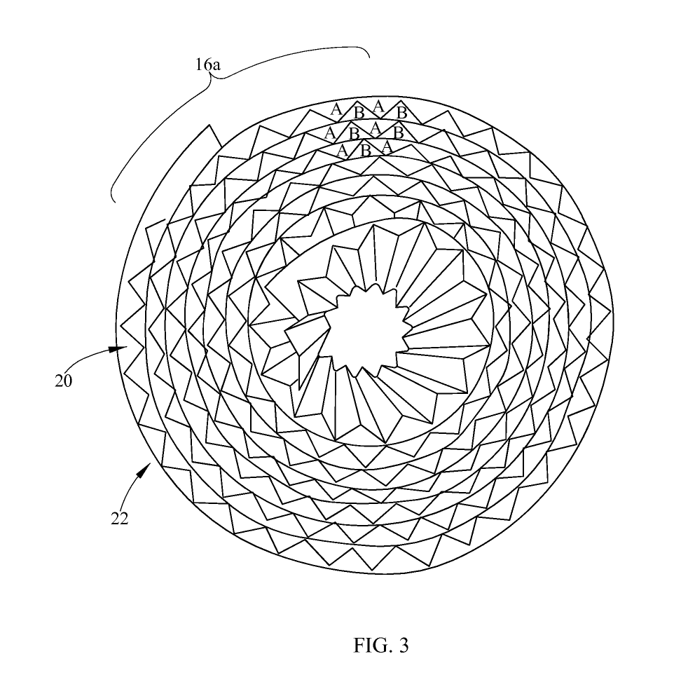

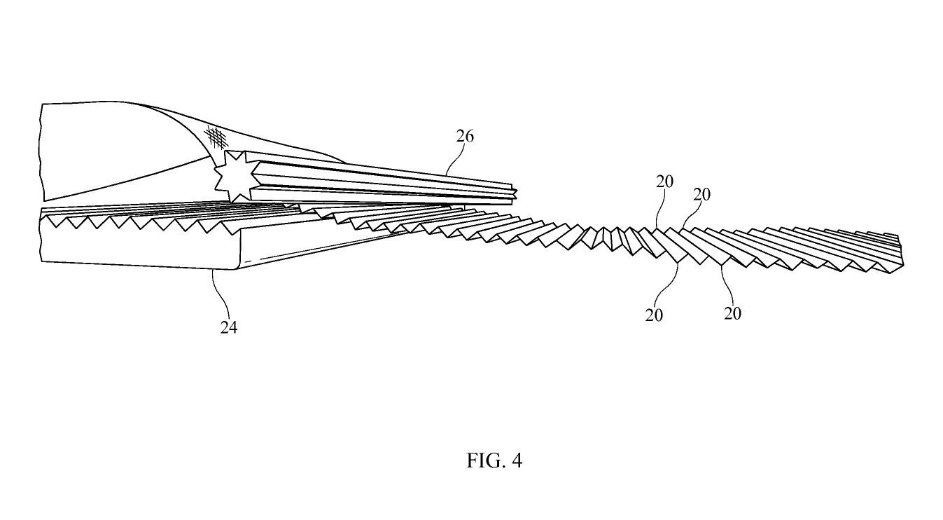

FIGS. 3 and 4 illustrates a corrugated (fluted) geometry of the fill material 16a where the fill material 16a is formed of a sheet of material with fluting 20 on either side of the sheet material. As seen in FIG. 4, the sheet material can be placed onto a jig 22 that has the appropriate fluting design thereon, with one surface of the sheet material laid overtop the jig and the opposing surface of the sheet material pressed into the jig 22 with an appropriate press 24 that has a corresponding fluting design thereon, thereby producing the mesh material 16a. Of course, other means can be used to produce the mesh material 16a. When the mesh material 16a is folded, each void produced by the fluting is filled with a different fluid A or B in staggered arrangement so that each void that has fluid A therein, is between two voids that each have fluid B therein. Because the compartments for fluids A and B are of equal size, spray distribution cannot discriminate between the compartments intended for fluid A and those intended for fluid B. Manifolds for fluid distribution are required for this corrugated geometry.

FIGS. 5 and 6 illustrate a hexagon-triangle geometry for the mesh material 16b of the fill material for direct contact heat/mass exchangers. The first fluid A flows through the hexagon voids 26 of this mesh material 16b, while the second fluid B flows through the triangle voids 28 of this mesh material 16b.

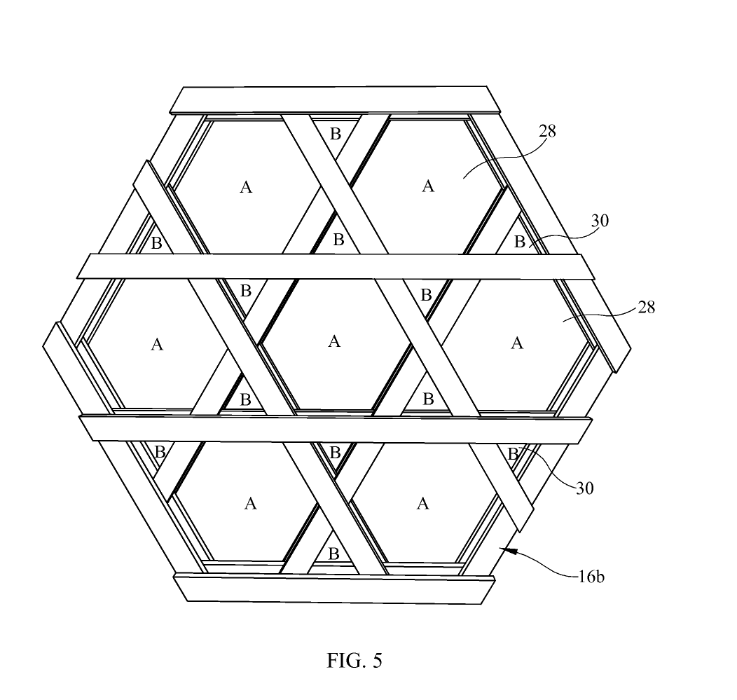

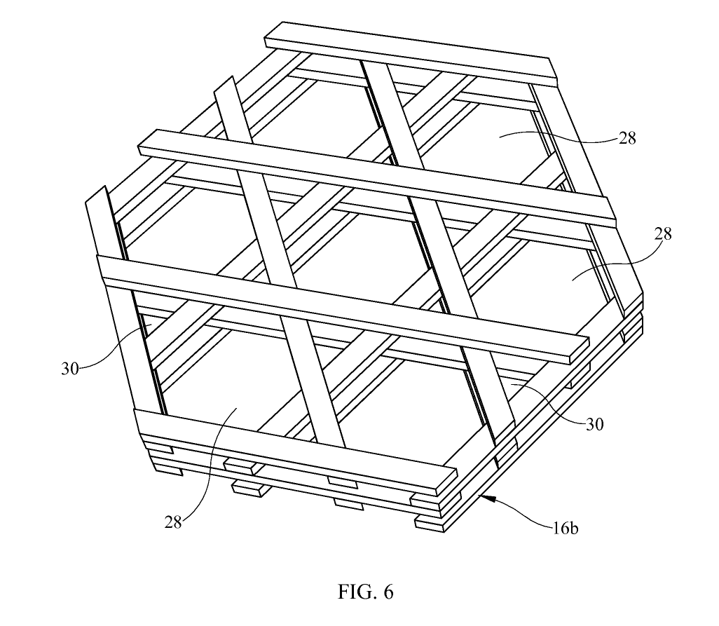

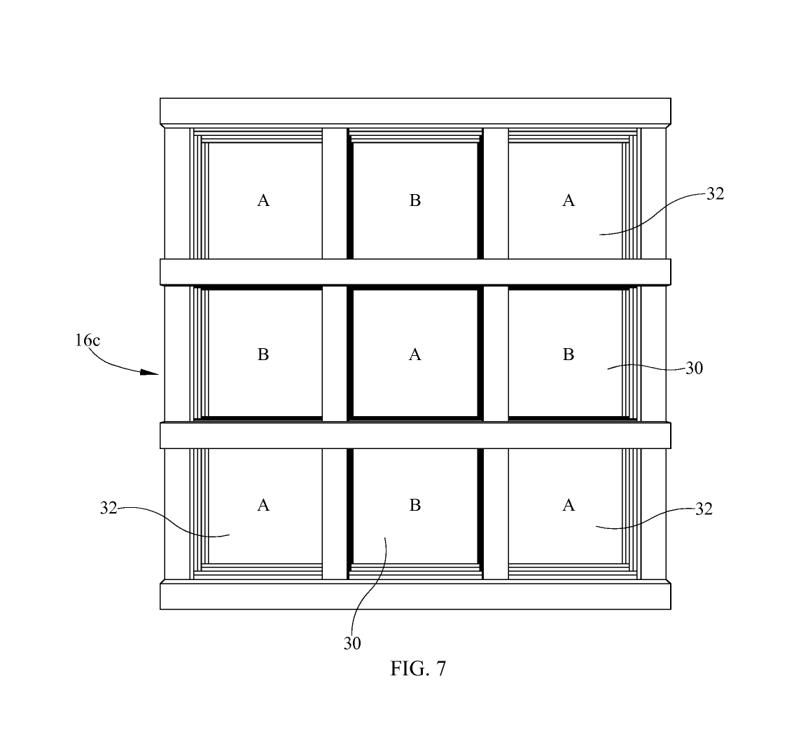

FIGS. 7 and 8 illustrate a square geometry for the mesh material 16c of the fill material for direct contact heat/mass exchangers having continuous square voids 28. The first fluid A and the second fluid B are staggered so that in any adjacent square void 30 of this mesh material 16c, the opposite fluid is present relative to all adjacent voids 30 for that particular void 30.

FIGS. 9 and 10 illustrate a triangle geometry for the mesh material 16d of the fill material for direct contact heat/mass exchangers having continuous triangle voids 32. The first fluid A and the second fluid B are staggered so that in any adjacent triangle void 32 of this mesh material 16d, the opposite fluid is present relative to all adjacent voids 32 for that particular void 32.

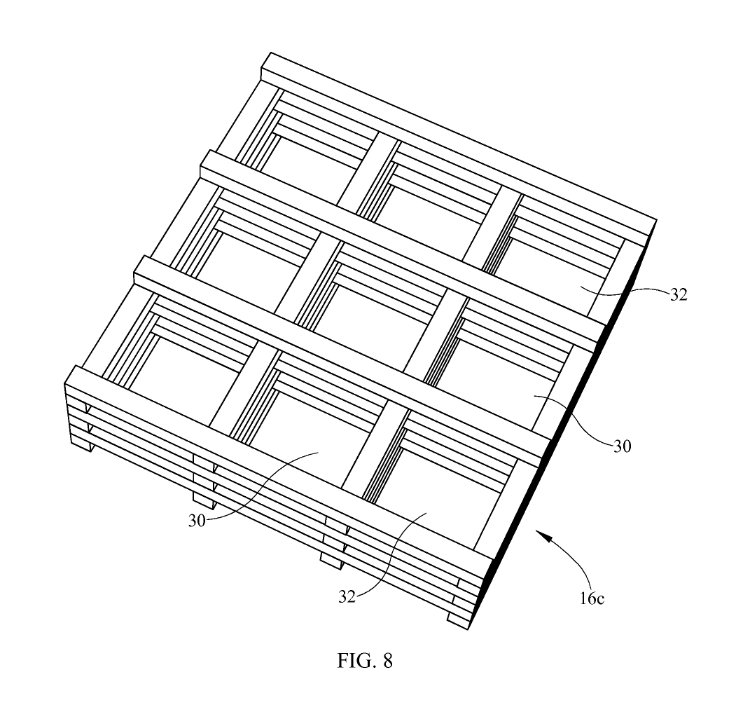

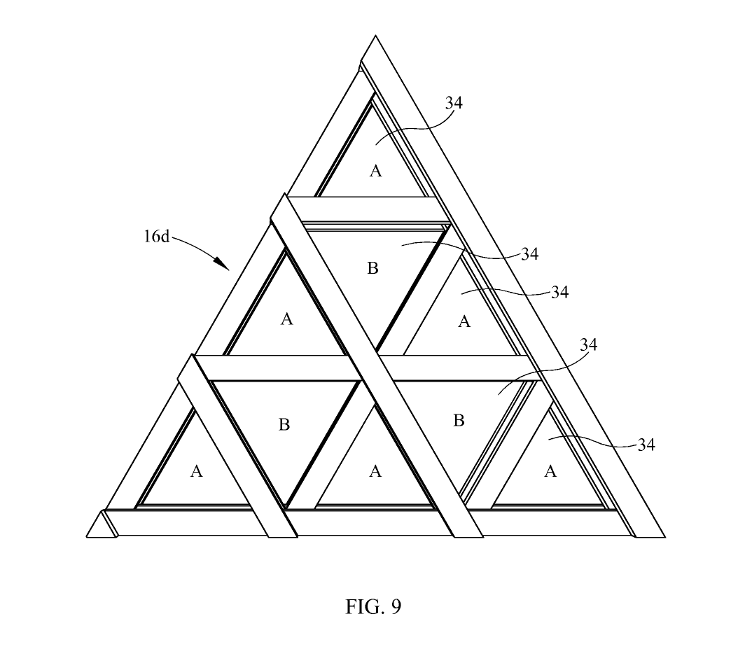

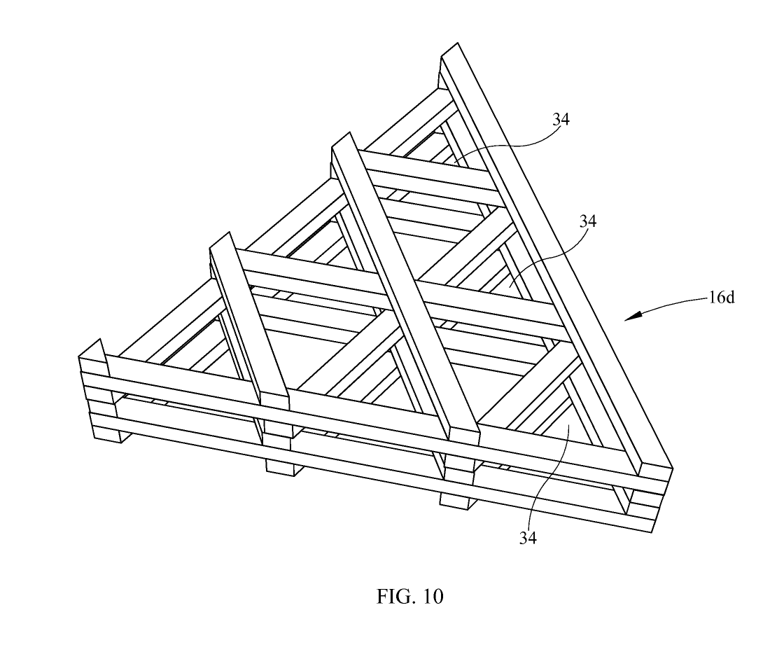

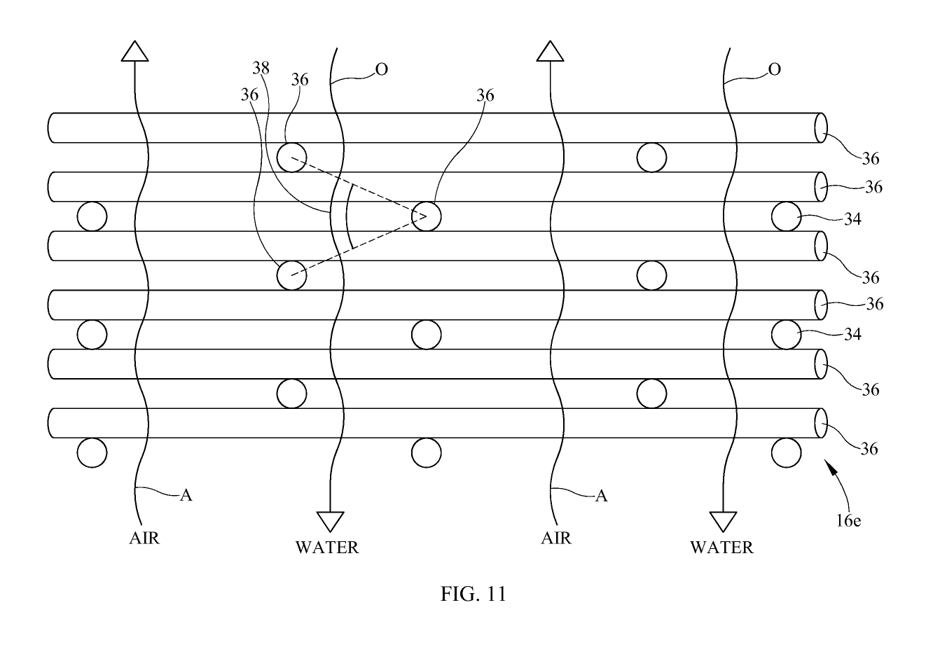

FIG. 11 is a schematic view of a mesh fill material 16e of the fill material for direct contact heat/mass exchangers for a contoured direct-contact heat exchanger for the evaporation or condensation of water with air wherein the larger volume is devoted to the air O because of its lower heat capacity and related larger volume flow requirements with the smaller volume for water W. The meshes of FIGS. 5-12 have the advantage of possible production with an additive manufacturing process that deposits linear elements 34 of a molten material through an extrusion nozzle. Such additive manufacturing processes have difficulty in producing suspended linear elements of material that are broken (as in a dotted line) or curved (due to surface tension of the molten deposition material acting to further round the curved portions of the line). The mesh material 16e has the following additional advantages. The indicated angle 36 between the fluid/fluid interface anchoring elements 34 is kept at less than 60 degrees to eliminate the need to introduce the fluids O and W in a particular order. By arranging the fluids O and W into volumes separated by parallel planes, both fluids are able to flow not just in one direction but in two perpendicular direction. Both dimensions of flow may be used simultaneously as oblique flow is required in contoured heat exchangers. Because the fluid/fluid interface anchoring elements 34 are staggered, they provide less resistance to and congestion of the fluid flow and allow for a greater area fraction of open aperture between the fluids (providing more heat/mass exchange, less friction, and less material cost) while still providing mechanical structure. Structural elements 35 hold the fluid/fluid interface anchoring elements 34 in place.

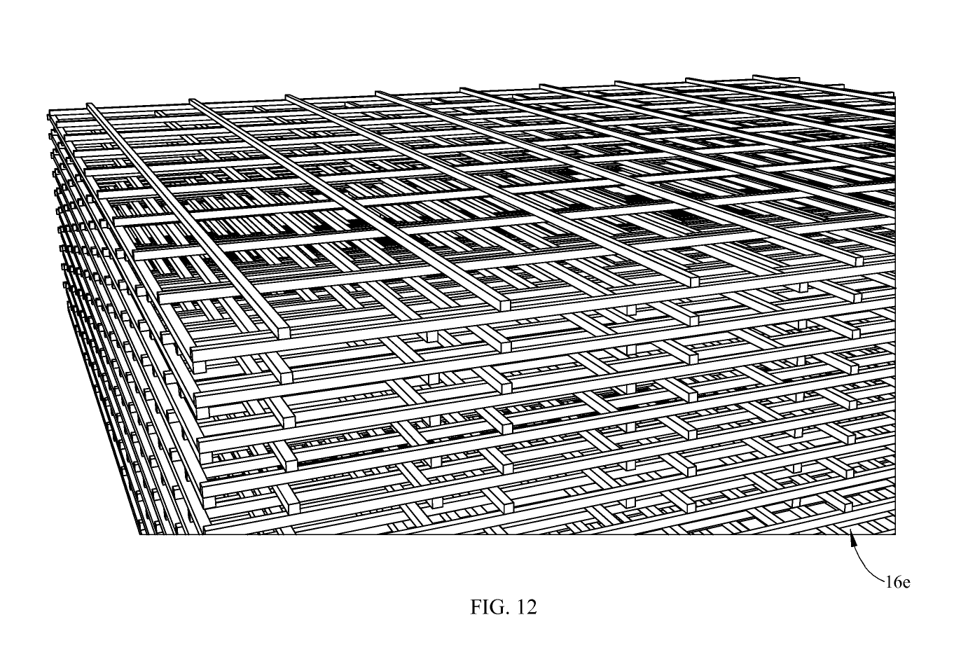

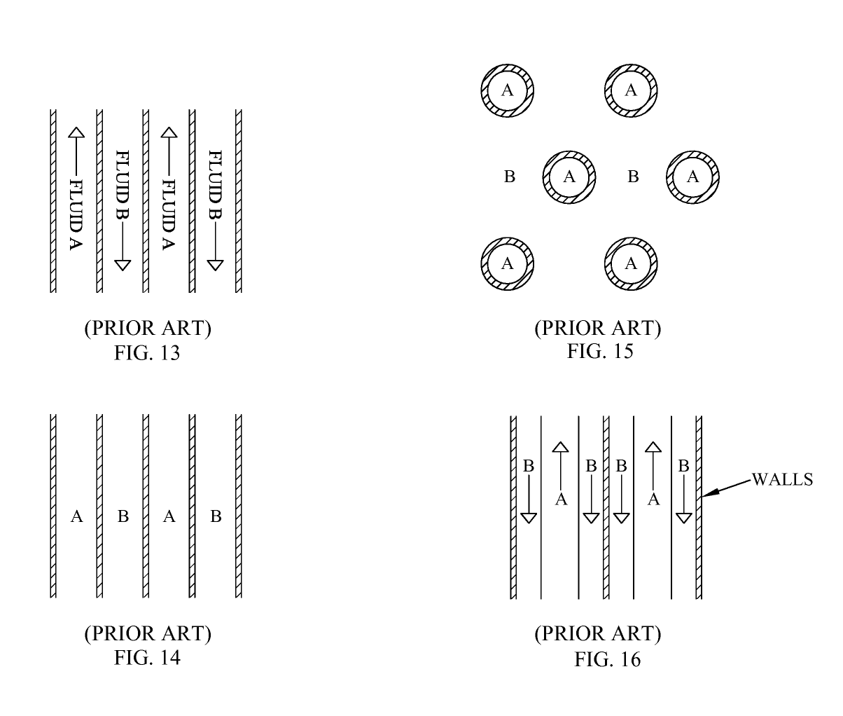

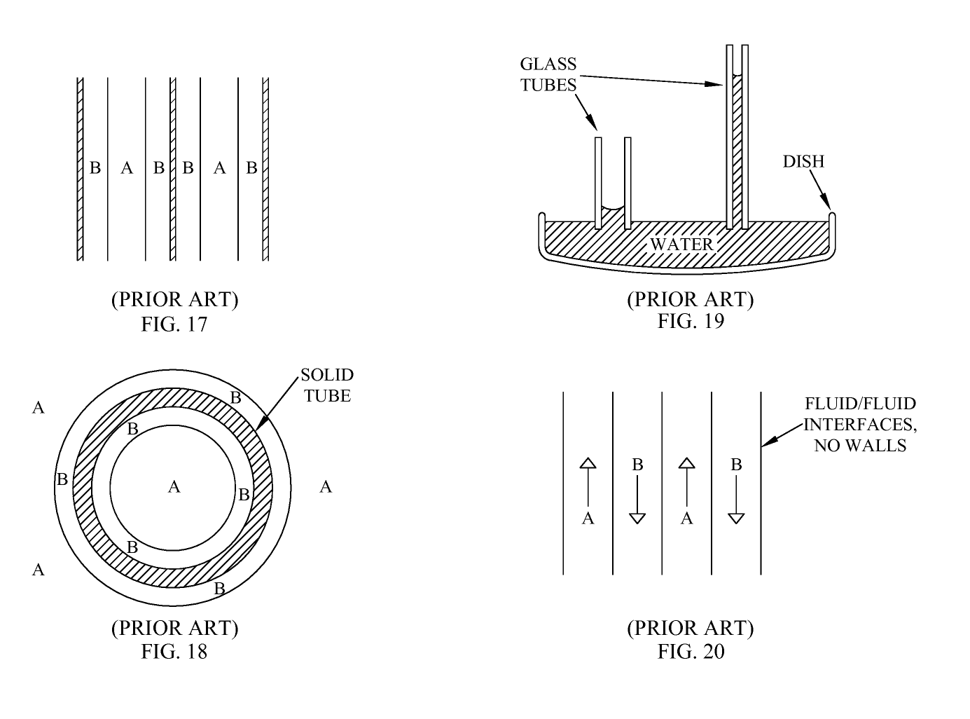

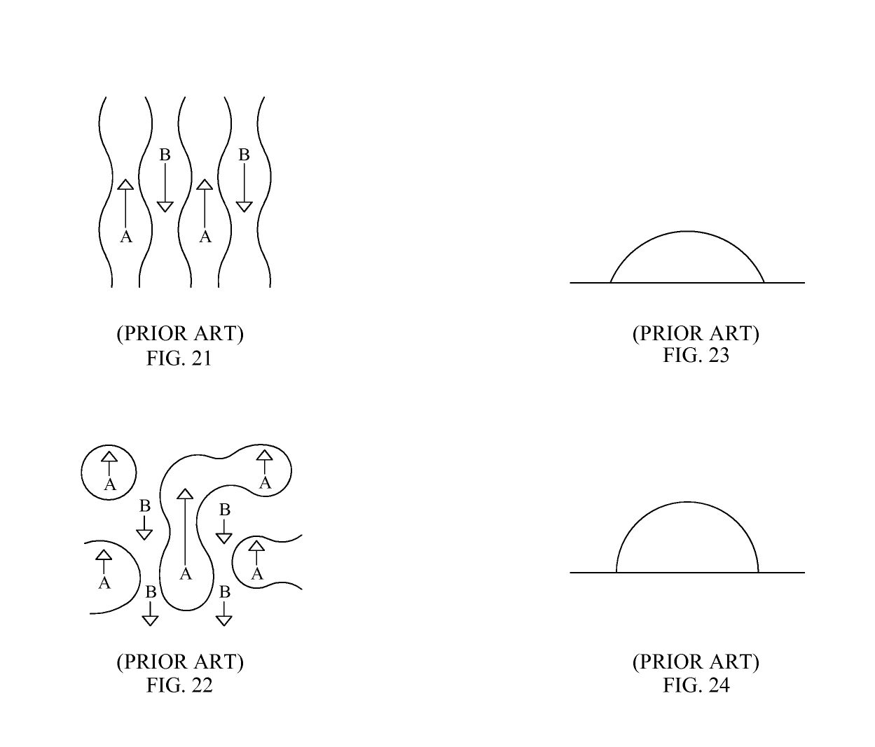

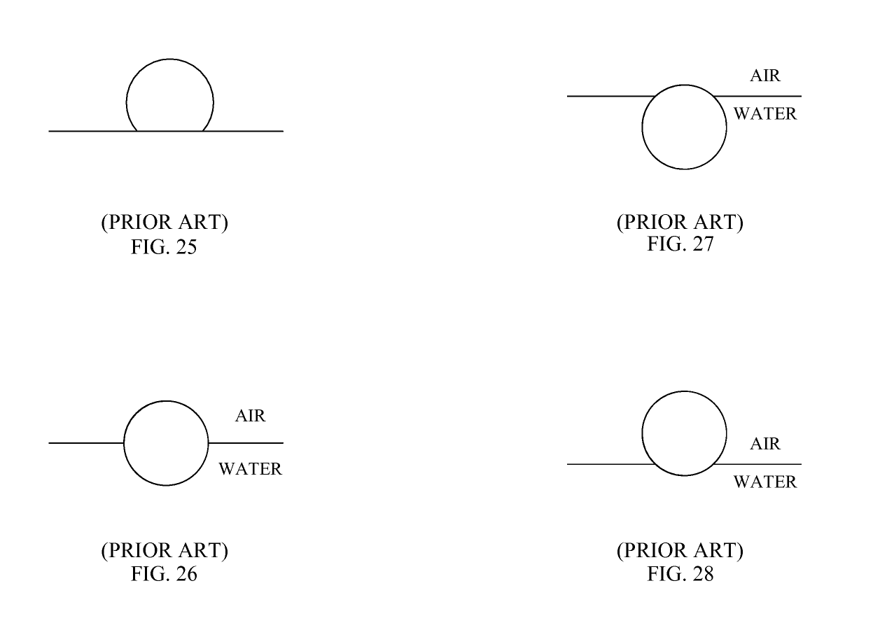

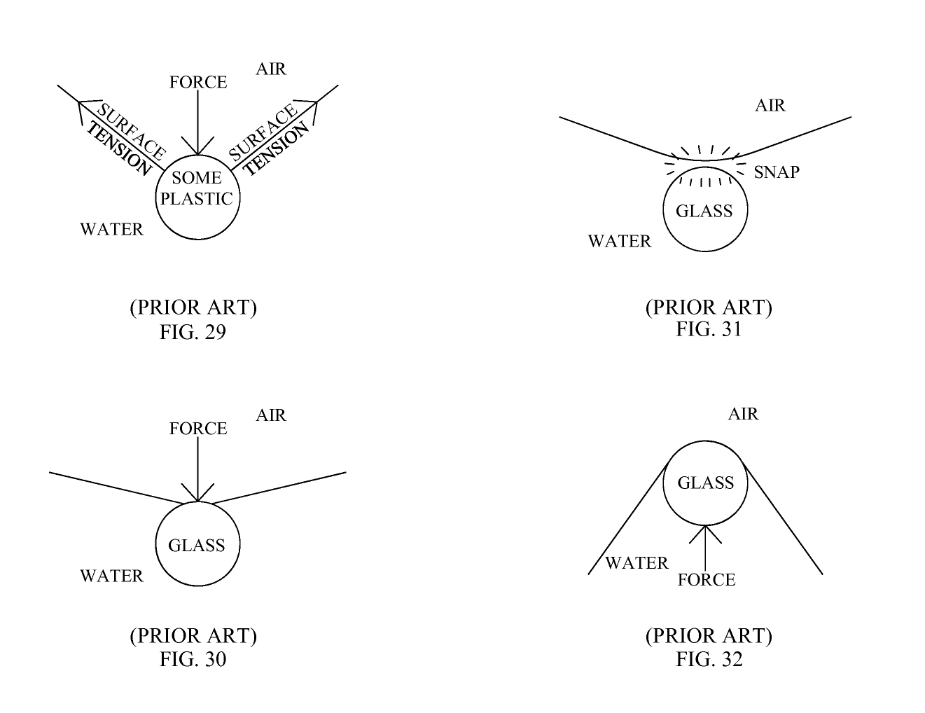

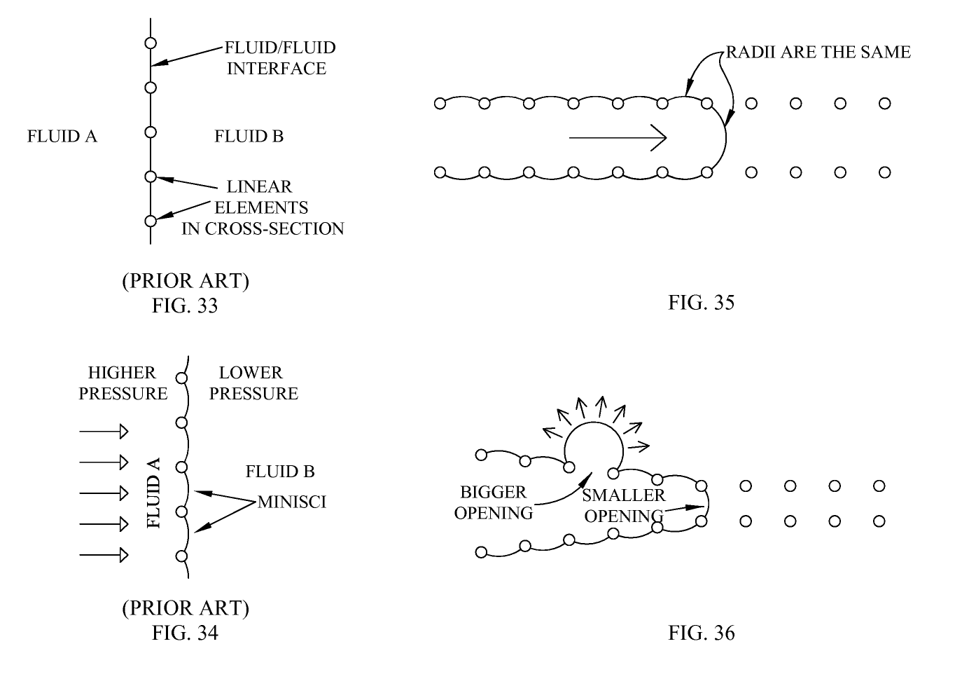

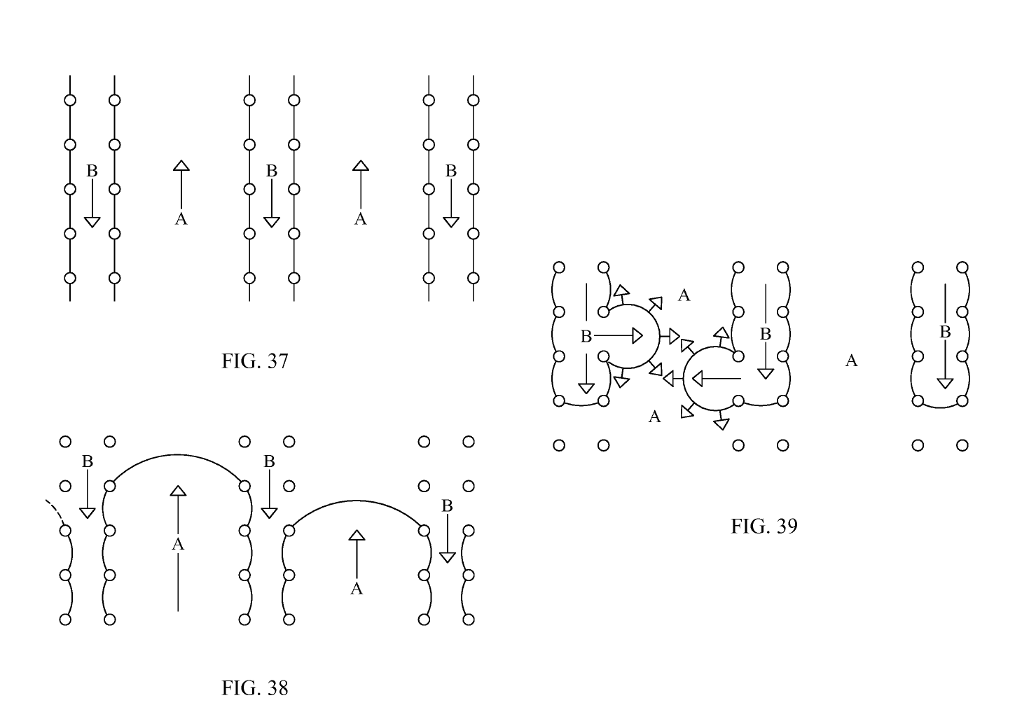

FIG. 12 is a perspective view of a mesh fill material 16e of FIG. 11.

The mesh material of the various configurations may be made from plastic or other suitable relatively inexpensive material, such material being chosen to advantageously provide a neutral wetting surface for the fluids A and B being used within the heat exchanger 12.

While the invention has been particularly shown and described with reference to an embodiment thereof, it will be appreciated by those skilled in the art that various changes in form and detail may be made without departing from the spirit and scope of the invention

1. A fill material for a direct contact heat/mass exchanger for heat/mass transfer between a first fluid and a second fluid, the fill material comprising a mesh having flow pathways bounded by an array of linear elements for voids between the linear elements, such that the mesh is placed between the two fluids within the heat exchanger, so that the mesh is touching both the first fluid and the second fluid.

2. The fill material as in claim 1 wherein the mesh is formed from a material that is approximately neutrally wetting to the first fluid and the second fluid.

3. The fill material as in claim 2 wherein the mesh uses surface tension and capillary action to anchor the first fluid/second fluid interface in a desired location.

4. The fill material as in claim 3 further comprising a collector in direct contact with the fill material to extract fluid from the heat exchanger without formation of large droplets.

5. The fill material as in claim 4 wherein the mesh directs the first fluid into spaces arranged as parallel planes to permit oblique flow of the first fluid and the second fluid.

6. The fill material as in claim 5 wherein the voids form a cubic pattern.

7. The fill material as in claim 6 wherein the voids form a triangular pattern.

8. The fill material as in claim 6 wherein the voids form an alternating hexagon triangle pattern

9. The fill material as in claim 5 wherein where the lines of the mesh forming the parallel planes run vertically.

10. The fill material as in claim 5 wherein where the lines of the mesh forming the parallel planes run horizontally.

11. The fill material as in claim 1 wherein the mesh uses surface tension and capillary action to anchor the first fluid/second fluid interface in a desired location.

12. The fill material as in claim 1 further comprising a collector in direct contact with the fill material to extract fluid from the heat exchanger without formation of large droplets.

13. The fill material as in claim 1 wherein the mesh directs the first fluid into spaces arranged as parallel planes to permit oblique flow of the first fluid and the second fluid.

14. The fill material as in claim 1 wherein the voids form a cubic pattern.

15. The fill material as in claim 1 wherein the voids form a triangular pattern.

16. The fill material as in claim 1 wherein the voids form an alternating hexagon triangle pattern

17. The fill material as in claim 1 wherein where the lines of the mesh forming the parallel planes run vertically.

18. The fill material as in claim 1 wherein where the lines of the mesh forming the parallel planes run horizontally.

19. A fill material for a direct contact heat/mass exchanger for heat/mass transfer between a first fluid and a second fluid, the fill material compromising a plurality of solid linear elements anchored to an interface of the first fluid and the second fluid to a location of the solid linear elements surface tension and capillary action, where the plurality of solid linear elements are in contact with both the first fluid and the second fluid at every point along each element's length.

20. The fill material as in claim 19 wherein the linear elements form parallel lines.

21. The fill material as in claim 19 wherein the linear elements form helixes.

22. The fill material as in claim 19 wherein the linear elements form a grid.
